(19) United States
(12) Patent Application Publication
(10) Pub. No.: US 2004/0220827 A1
(43) Pub. Date: Nov. 4, 2004

(54) Sponsorship exchange and auction

(76) Inventors: Duane Allen Ansel, Seattle, WA (US); Amy Kathleen Ansel, Seattle, WA (US)

Correspondence Address: STOEL RIVES LLP, 900 SW FIFTH AVENUE, SUITE 2600, PORTLAND, OR, 97204, US

(21) Appl. No.: 10/775,757

(22) Filed: Feb. 9, 2004

Related U.S. Application Data
(60) Provisional application No. 60/445,719, filed on Feb. 7, 2003.

(51) Int. Cl. G06F 17/60

(52) U.S. Cl. 705/1

(57) ABSTRACT

A web-based sponsorship exchange facilitates forming an agreement between an “owner” of a marketing, sales, technical, or other business event and one or more asset/service providers in which fees for services/assets to be provided for the event are leveraged in full or in part by service/product placements, advertising, and other sponsorship or marketing opportunities for the asset/service provider related to the event or the event owner. The sponsorship exchange sets up a quid pro quo benefiting the event owner in the form of no-cost, or nominal/reduced fee services or assets. In turn, the asset/service provider receives product placement, branding or other advertising at an venue without direct payment. Further, a sponsorship opportunity auction is implemented in association with a certain event and can be bid upon and won in exchange for cash or other compensation, assets or services. The invention is applicable across a wide spectrum of industries.

### RELATED APPLICATIONS

This application claims priority from U.S. Provisional Application No. 60/445,719 filed Feb. 7, 2003 and incorporated herein by this reference.

### APPENDIX

This disclosure includes an appendix immediately preceding the claims.

### TECHNICAL FIELD

The present invention is directed to e-commerce, and is particularly concerned with trading event sponsorship opportunities for certain assets, services, or compensation useful in putting on such an event or the event owner.

### SUMMARY OF THE INVENTION

A first aspect of the invention is generally directed to a web-based sponsorship exchange which facilitates an agreement between an “owner” of a marketing, sales, technical, or other business event and one or more asset/service providers in which fees for services/assets to be provided for the event are leveraged in full or in part by service/product placements, advertising, and other sponsorship or marketing opportunities for the asset/service provider related to the event or the event owner. In particular, in exchange for such sponsorship or marketing opportunities, including, but not limited to co-branding and joint marketing activities and ventures involving the asset/service provider and event owner, the sponsorship exchange sets up a quid pro quo benefiting the event owner in the form of no-cost, or nominal/reduced fee services or assets. In turn, the asset/service provider is getting product placement, branding or other advertising at an venue it would otherwise have to pay for, if it were even available to begin with. This sponsorship exchange would be conveniently applicable to a technology company (event owner) planning a trade show or product announcement (event) to tout of one or more of its software products. In exchange for certain computing platform hardware loaned to the technology company useful to demonstrate the new software release(s), the technology company would permit the hardware vendor to brand or co-brand certain aspects of the trade show or products with it's own trademarks, slogans, and other distinguishing or market differentiating indicia.

A second aspect of the invention is generally directed to a sponsorship auction in which sponsorship or marketing opportunities, such as preferred/exclusive product placement, signage, co-branding, advertising and leadership access associated with a certain event or event owner can be bid upon and won in exchange for cash or other compensation, assets or services. In this aspect, sponsorship listings for multiple events and event owners can be maintained, and bidding can occur on a per event or event owner basis. This sponsorship auction is believed useful in that e.g. the event owner can reduce costs for putting on events, while opening up sponsorship opportunities enormously.

Though not intended to be limiting in any way, this sponsorship auction is believed to provide commercial appeal to managing sponsorship opportunities in the: 1) entertainment industry, including celebrity, actor and singer promotion and marketing; 2) the medical industry, including drug, facility, procedure, and service provider promotion and marketing; 3) technology industry marketing and promotion; and 4) sports, including individual athlete and team marketing and promotion at both the intercollegiate and professional level. In each of these vertical markets, sponsorship opportunities can be provided by or for an entity defined thereby (e.g. the celebrity, athlete, organization, or sports team). The entity can serve as the event owner, or the asset/service provider, also known as a sponsor.

Additional aspects and advantages of this invention will be apparent from the following detailed description of particular embodiments, which proceeds with reference to the accompanying drawings.

### BRIEF DESCRIPTION OF THE DRAWINGS

FIGS. 1A-1C are flowcharts illustrating aspects of sponsorship exchange processing according to an embodiment of the invention.

FIG. 2 is a functional block diagram of a system capable of implementing the sponsorship exchange process shown in FIGS. 1A-1C.

FIG. 3 is a web browser screen shot illustrating an asset/services request summary consistent with the embodiment shown in FIGS. 1A-1C.

FIG. 4 is a web browser screen shot depicting an asset/services request receipt consistent with the embodiment shown in FIGS. 1A-1C.

FIGS. 5A, 5B and 5C are web browser screen shots collectively depicting a sponsorship offer consistent with the embodiment shown in FIGS. 1A-1C.

FIG. 6 is a web browser screen shot illustrating requests for a particular event owner.

FIGS. 7A-7C are web browser screen shots collectively depicting a sponsorship offer presentation to the event owner consistent with the embodiment shown in FIGS. 1A-1C.

FIGS. 8A and 8B are web browser screen shots collectively illustrating electronic contracting of approved sponsorship offers consistent with the embodiment shown in FIGS. 1A-1C.

FIG. 9 is a web browser screen shot depicting another type of electronic contracting of approved sponsorship offers consistent with the embodiment shown in FIGS. 1A-1C.

FIGS. 10A-10D are web browser screen shots collectively depicting a sponsorship offer with a technical support service provider.

FIG. 11 is a web browser screen shot listing requests associated with a particular provider, consistent with the embodiment shown in FIGS. 1A-1C.

### DETAILED DESCRIPTION

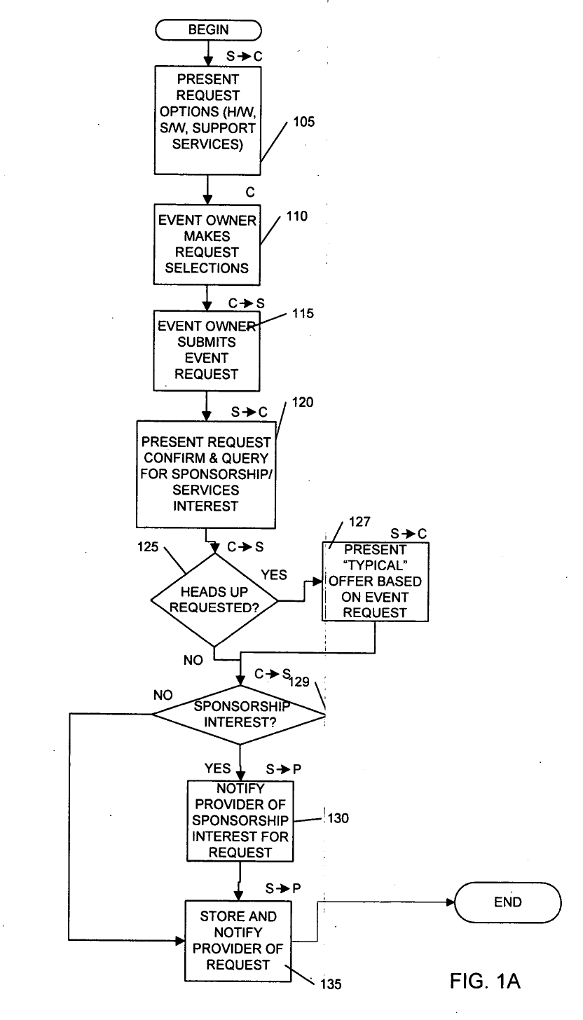

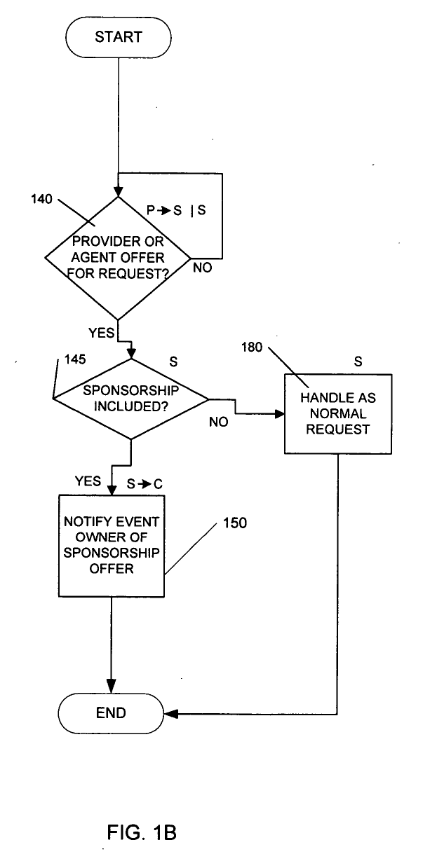

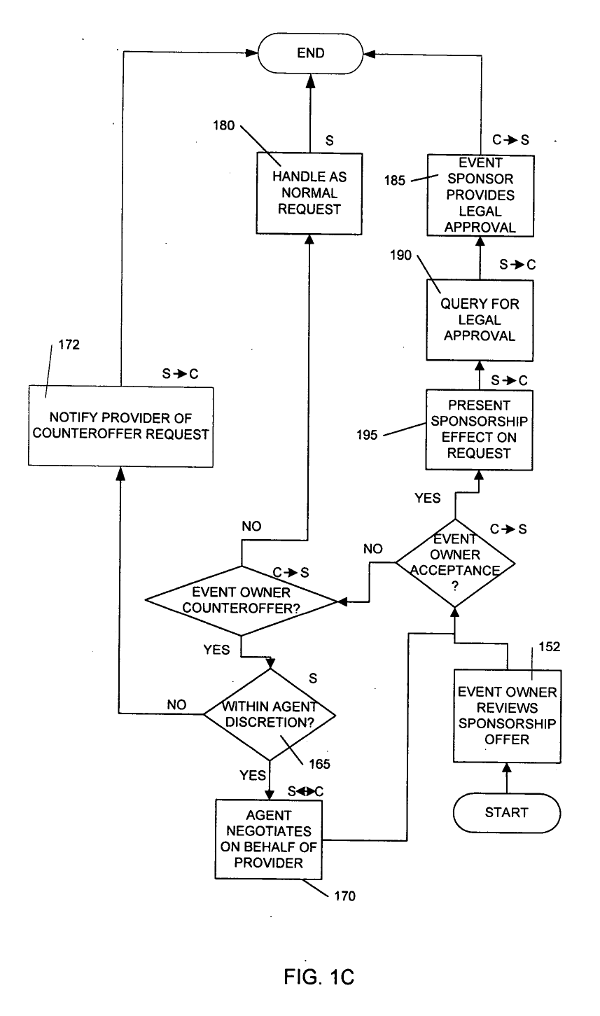

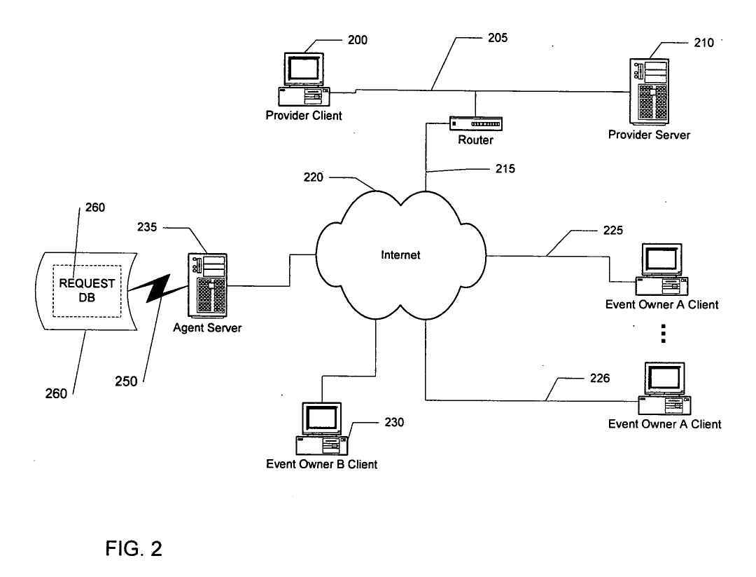

Details of sponsorship exchange processing according to an embodiment of the invention will now be discussed with reference primarily to FIGS. 1A-1C and 2, though other figures will be referenced as well. Though not required, this process may be conveniently implemented in a browser-based client—web server environment such as the system generally shown in FIG. 2. Accordingly, the processing steps, decisions and actions shown in FIG. 1A-1C may be labeled as follows: “S” refers to a process step, decision or action undertaken by a web server such as the agent server 235 shown in FIG. 2; “C” refers to a process step, decision, or action undertaken by a client-browser such as the event owner A clients 225, 226 or the event owner B client 230; “S→C” refers to a process step, decision, or action involving a communication from the web server to the browser client, such as a message originating from the agent server 235, passing through the Internet 220 and terminating at one of the clients 225, 226 or 230; “C→S” refers to a process step, decision, or action involving a communication from the browser client to the web server, such as a message originating from the event owner A client 225, passing again through the Internet 220 and terminating at the agent server 235; and “S⇄C” indicates a process step, decision, or action involving bidirectional communication between the web server and a client browser, such as between the agent server 235 and the event owner A client 225. The labels “S→P” and “P→S” indicate a process step, decision, or action between the server (such as the agent server 235) and the service or assets provider, such as system 240, including the provider server 210 constituting a part thereof.

Though not intended to be limiting in any way, the present embodiment will be described in the context of a particular type of event in which computing platform and associated software rentals, along with information technology support services directed to deploying, maintaining, and/or tearing down and returning such rentals are sought by the event owner. Thus, in this embodiment the likely asset/service providers would include computer hardware and software vendors specializing in short term leasing, as well as information technology (“IT”) services vendors who can service the leased equipment and software.

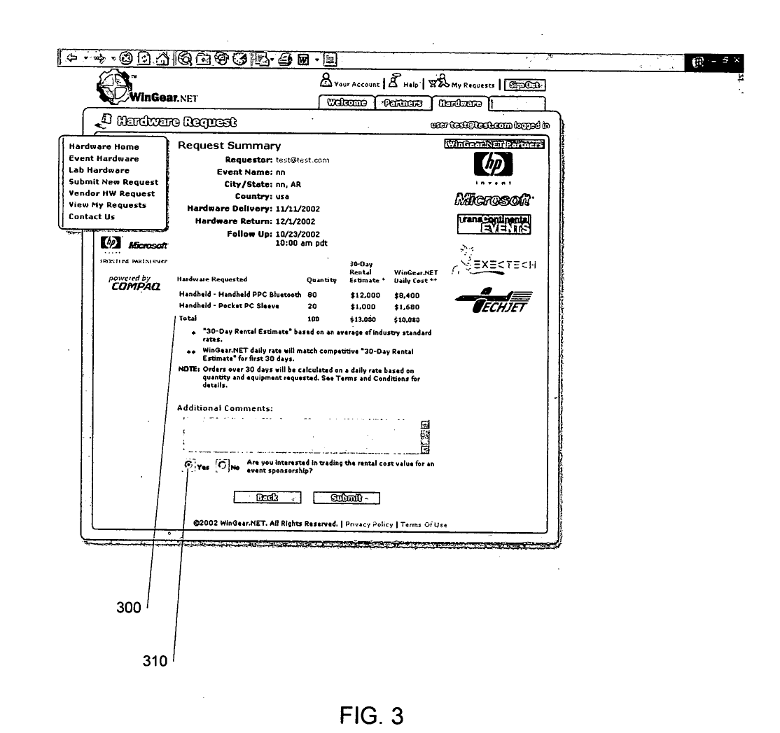

Turning specifically to FIG. 1A, asset/services request submission of sponsorship exchange processing according to the present embodiment begins at step 105, in which the agent server 105 presents request options to an event owner client (and ultimately, via an appropriate computer interface such as a display, to the event owner) for short term rental of computer hardware and software for an event, as well as any required IT or other support services. Control then passes to step 110, in which the event owner, preferably through interaction with one or more of the client browsers 225, 226 or 230 available to the event owner, makes a request of specific computer hardware, software or services from an online catalog (not shown) maintained by the agent server 235. After the event owner is finished with setting up the assets/services request, control passes to step 115 in which the selected client browser(s) 225, 226, 230 relay the completed request including asset/services selections made to the agent server 235. Next, at step 120, the agent server 235 causes the selected client browser to display to the event owner the just completed assets/services request, and also prompts the event owner whether there is interest in a sponsorship trade for any of the assets/services selections. A sample client browser display of the request confirmation 300 including the sponsorship interest prompt 310 is provided in FIG. 3.

At step 125, a determination is made whether the event owner has, through operation of the selected client browser(s) 225, 226 or 230, has asked for “typical” or customary sponsorship offer based on the current request. Though this feature is not shown in FIG. 3, it can easily be initiated as a hotlink to a dynamic webpage as is known in the art. If, in step 125, the agent server 235 determines that the event owner does want to see the typical sponsorship offer, processing continues at step 127 in which the server 235 provides the typical sponsorship offer, through a dynamically populated popup webpage or similar construct viewable on the selected client browser. Processing then proceeds on to step 129. If, however, in step 125, if it is determined that the event owner does not want to review the typical sponsorship offer, processing instead directly passes to step 129.

At step 129, a determination is made by the agent server 235 whether the event owner indeed wants to consider sponsorship trade for assets/services presented in the confirmed request. If so, processing continues to step 130 in which the agent server 235 apprises the provider system(s), such as system 240 and at least one of the provider server 210 and the provider client 200, of the event owner's sponsorship interest for the request using appropriate messaging conveyable through the Internet 220, and then processing continues at step 135. If, however, it is decided that the event owner does not want a provider offer which includes sponsorship trade, processing bypasses step 130 and proceeds directly to step 135.

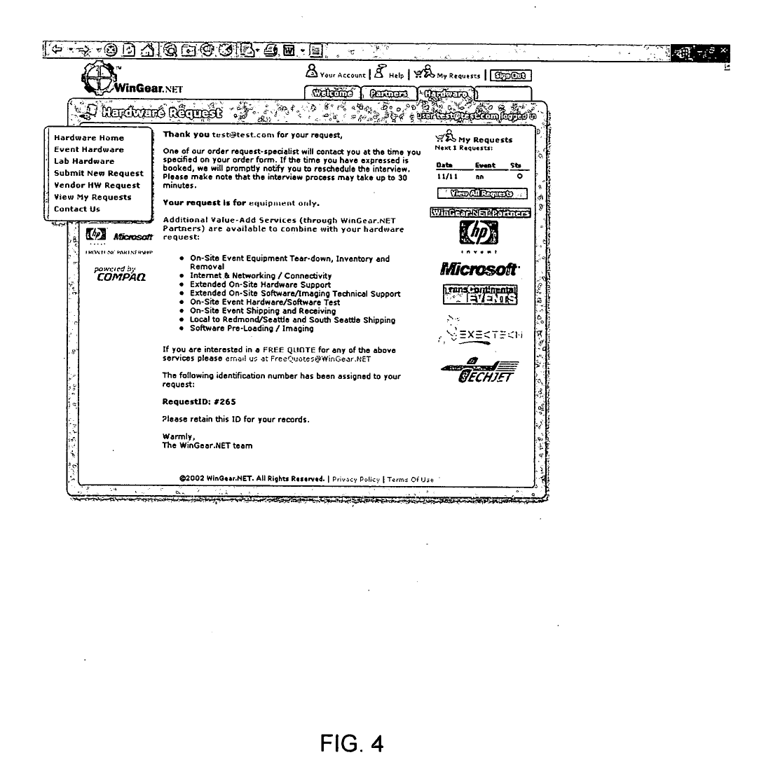

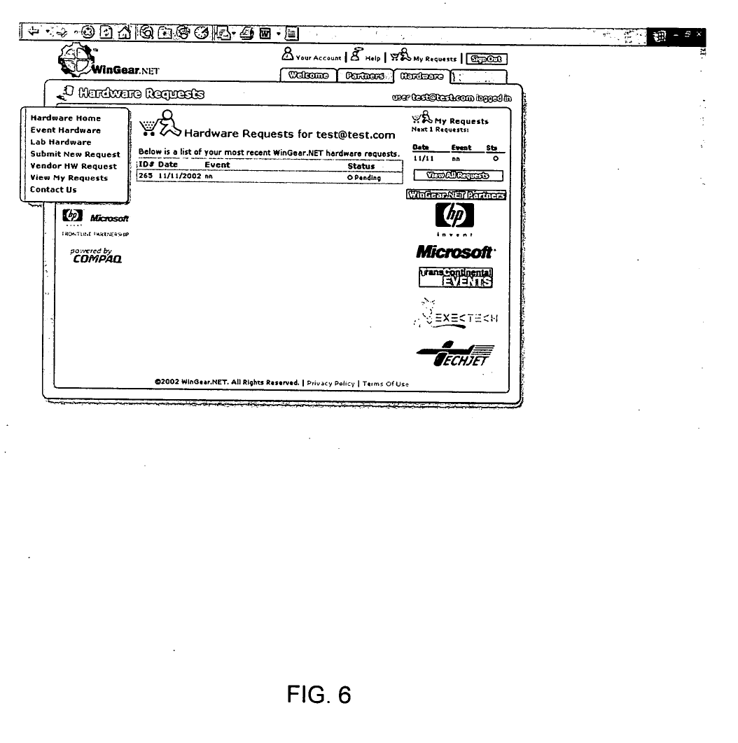

At step 135, the agent server 235 stores the request in a request database 260 accessible to the agent server 235 through the communications link 250, and notifies the provider system(s), such as system 240, of the request as well as notify the event owner that the request is “pending” (see e.g. the FIG. 4). As would be appreciated by those skilled in the art, the requests database 260, and storage unit 255 can generally and interchangeably constitute a portion of the agent server 235 itself, or be separately housed but in physical proximity of or at least in accessible communication therewith. As such, it is contemplated in the present embodiment that pending, approved and other types of requests can be presented and reviewed through an event owner's browser or other suitable interface, as shown in FIG. 6.

As shown in FIG. 3, it should be noted that the present embodiment includes a unitary sponsorship interest radio button query even though more than one potential provider may be solicited, as would be understood by those skilled in the art. In another embodiment, sponsorship queries can be made for each provider implicated in the request. Further, in such embodiment, the agent server can indicate whether sponsorship is possible with respect to one or more of these providers.

Provider/agent offer management sponsorship exchange processing according to the present embodiment will now be detailed with reference to FIG. 1B. Processing begins at step 140, in which the agent server 235 awaits whether a provider offer for a pending asset/services request has been received, or if within the discretion of a provider's agent, if within the agent's discretion. Though not required, scope of agency or discretion may be defined using known expert system rules techniques, and a rules-based assessment can be made for the pending asset/services requests managed by the agent server 235 against these agent definitions. Alternatively, such assessment may be handled manually with reference to the pending request at issue. If, for example, an assessment is made that the event is within an agent's discretion, the agent server 235 may interact with the agent, human or artificial, and seek the agent's guidance to construct an appropriate offer (not shown in any of FIGS. 1A-1C), which may or may not include event or event owner sponsorship trade consistent with the agent's directives from the provider it represents. If, however, an assessment is made that no agency exists or the pending request exceeds the agent's discretion or authority, the agent server 235 awaits for an offer from the provider(s) directly until an offer is received directly by that provider, the scope of agency is enlarged, or the pending request becomes stale (e.g. no provider response within 10 days of submission pursuant to step 135 of FIG. 1A).

Once a provider offer has been received, processing progresses to step 145 in which the offer is parsed to determine whether the provider offer includes a sponsorship component. If not, the offer is handled conventionally and either finalized or rejected by the event owner (step 180). If, however, the provider offer includes a sponsorship component, the provider offer is deemed to be a sponsorship offer, and processing instead progresses to step 150, in which the event owner is notified of the sponsorship offer. Notification can be through a number of known push techniques such as email, instant messaging or the like, as well as a pull techniques such as marking the pending request in the pending request database 260 to visually or otherwise indicate to the event owner that a sponsorship offer has been received pursuant to his request.

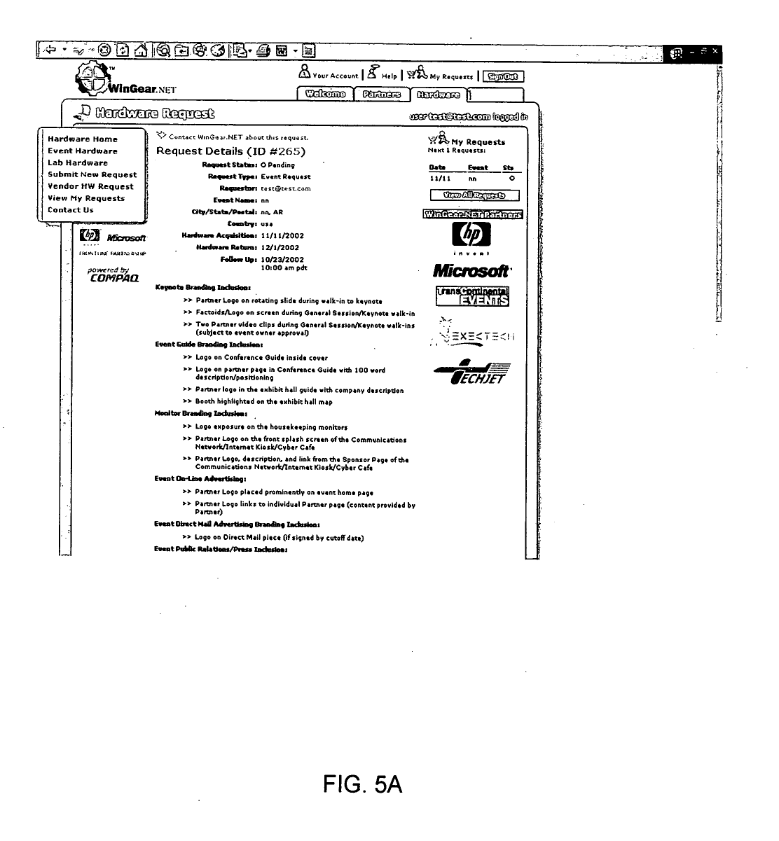

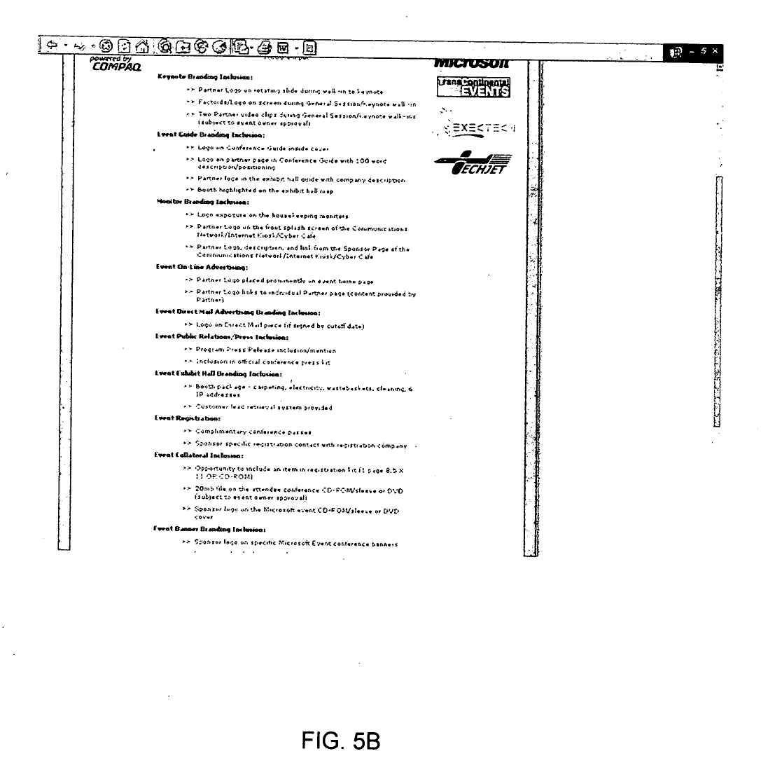

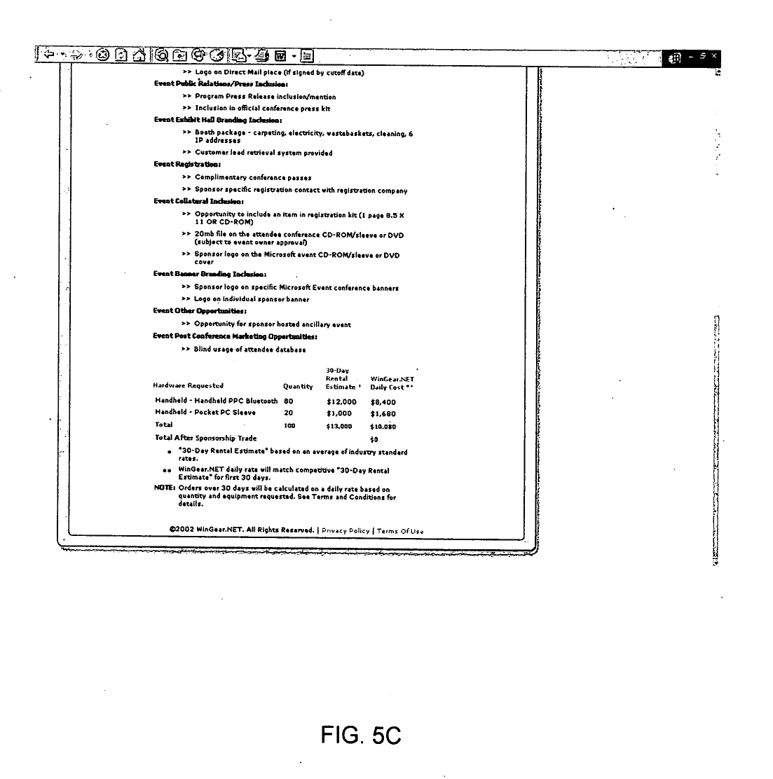

Note here that the sponsorship offer can include an array of sponsorship opportunities (the variety of potential opportunities would be limited only by a marketeer's imagination in the context of the event or event owner, restrained only by ethics and the law), including those listed in the sponsorship offer presented in FIGS. 5A-5C.

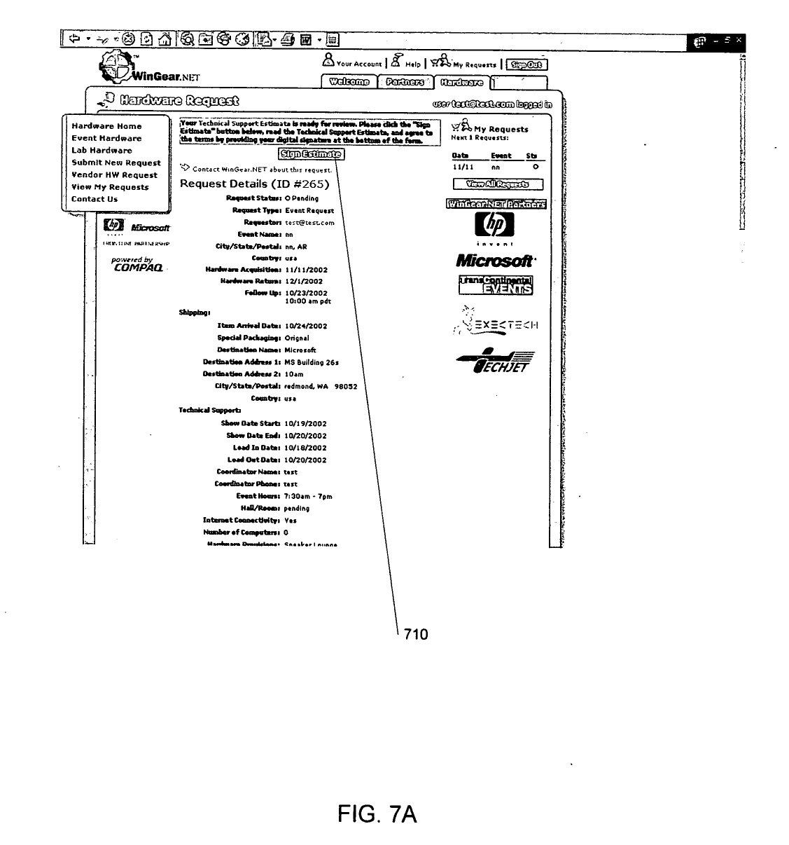

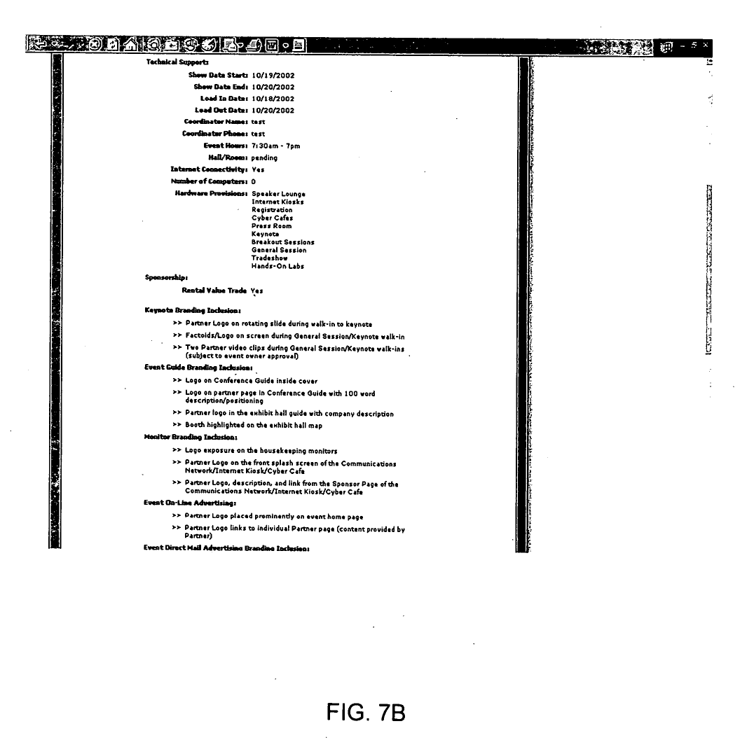

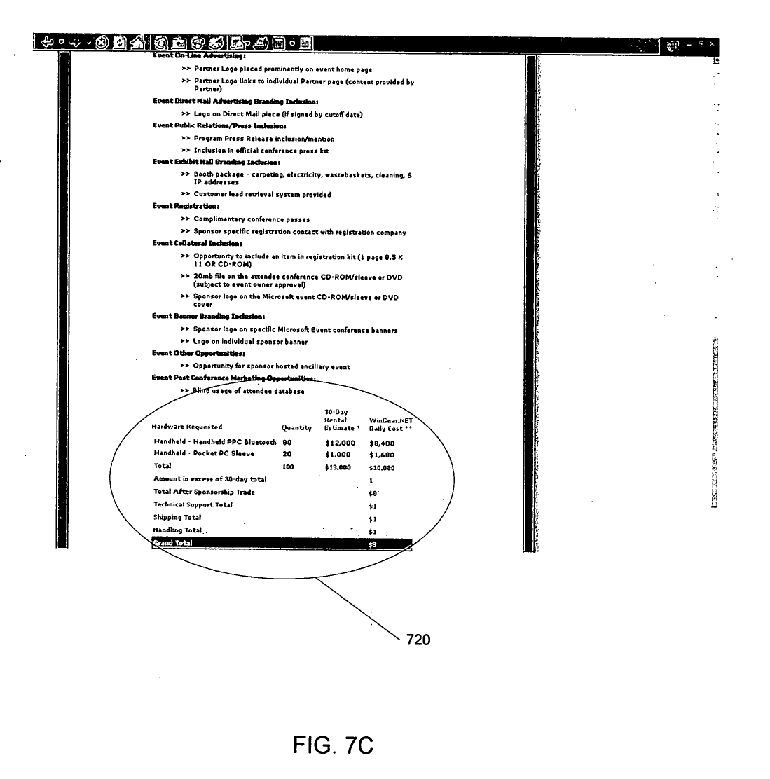

Sponsorship offer negotiation and disposition for the sponsorship exchange of the present embodiment will now be detailed with respect to FIG. 1C. Processing begins here with the event owner requesting to review the sponsorship offer to which he was notified in e.g. step 150 of FIG. 1B (step 152). Thereafter, at step 155 the event owner is prompted for acceptance of the offer (see, e.g., radio button 710 of FIGS. 7A-7C) and the agent server 235 awaits the event owner's decision. If the event owner does not agree or accede to the sponsorship offer, processing continues at step 160, in which a determination is made by the agent server 235 whether the event owner proposes a counteroffer (based on appropriate challenge and response). If a counteroffer is proposed, processing progresses to step 165 in which a determination is made whether the counteroffer is within the discretion of the agent, and if so, proceeds to step 170, in which the agent (here manually) negotiates on behalf of the provider associated with the rejected sponsorship proposal. Thereafter, processing loops back to step 155.

If, however, in step 165, it is decided that the event owner's counteroffer exceeds the agent's discretion, control instead passes to step 172 in which the provider is notified of the counteroffer request and the counteroffer is stored in the request database 260.

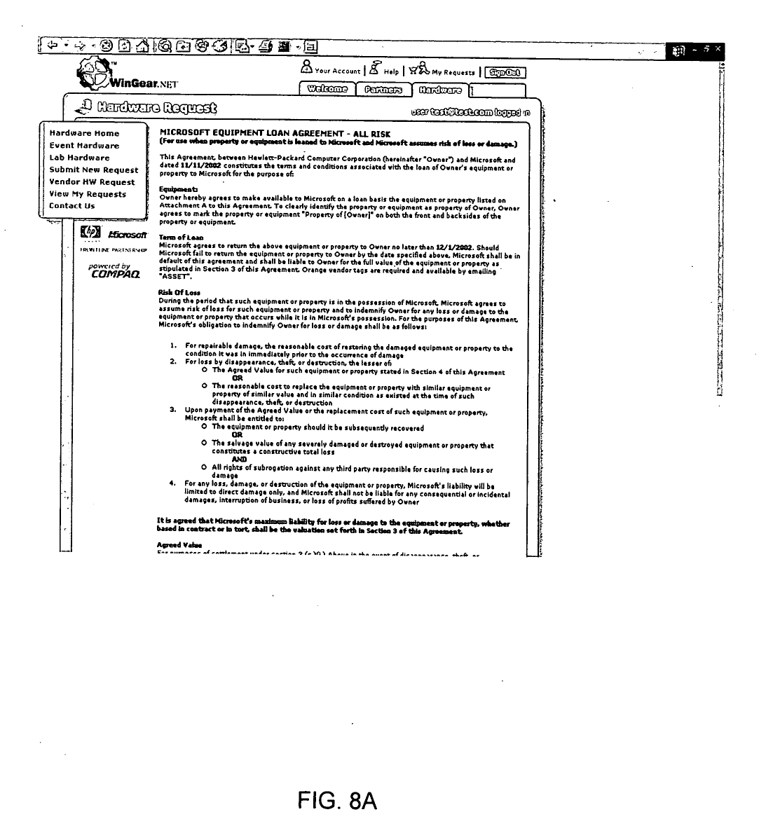

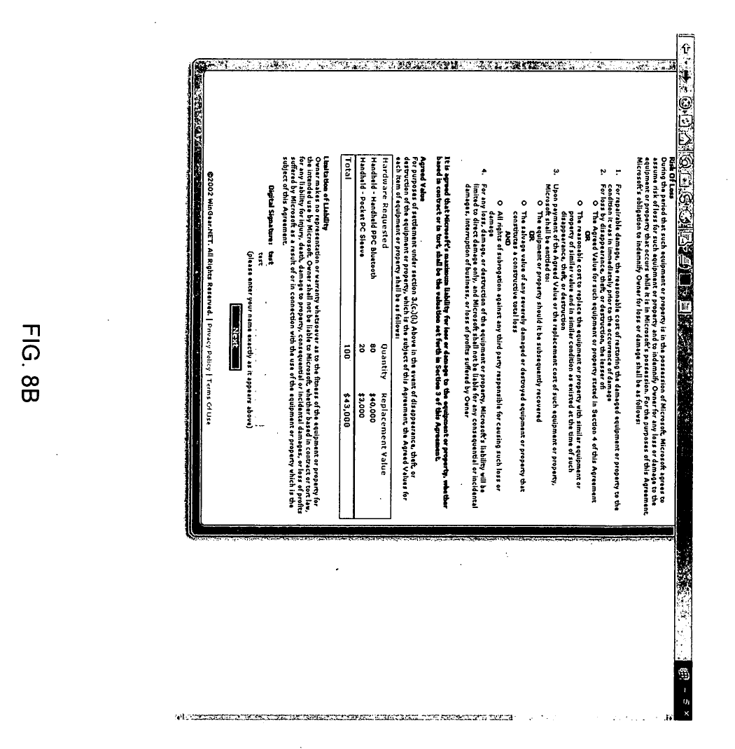

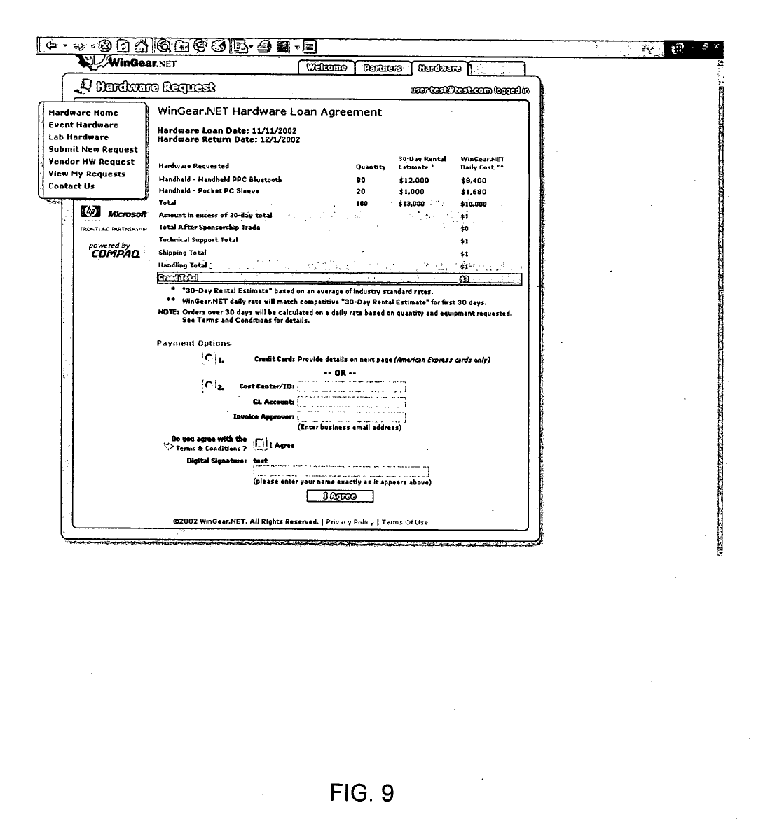

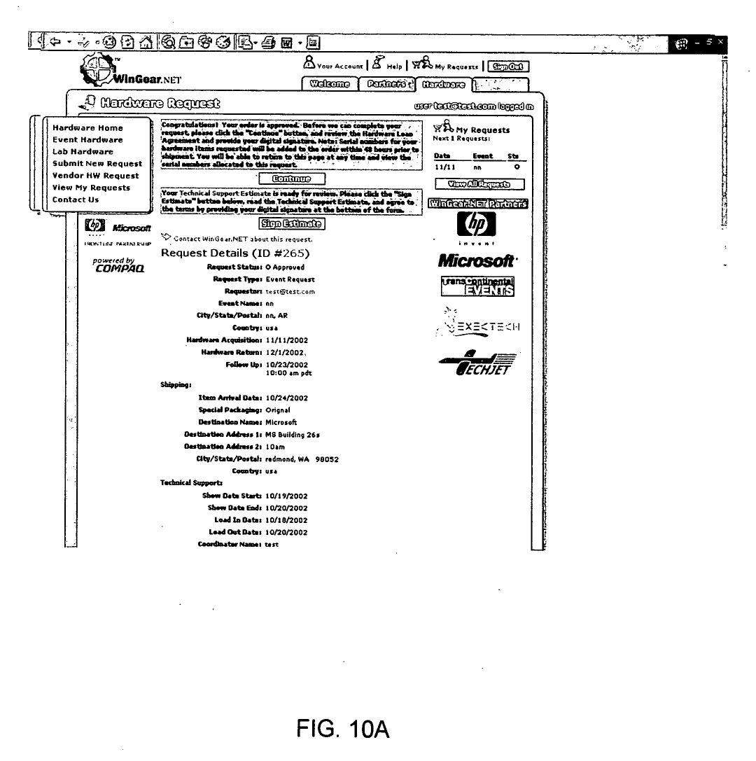

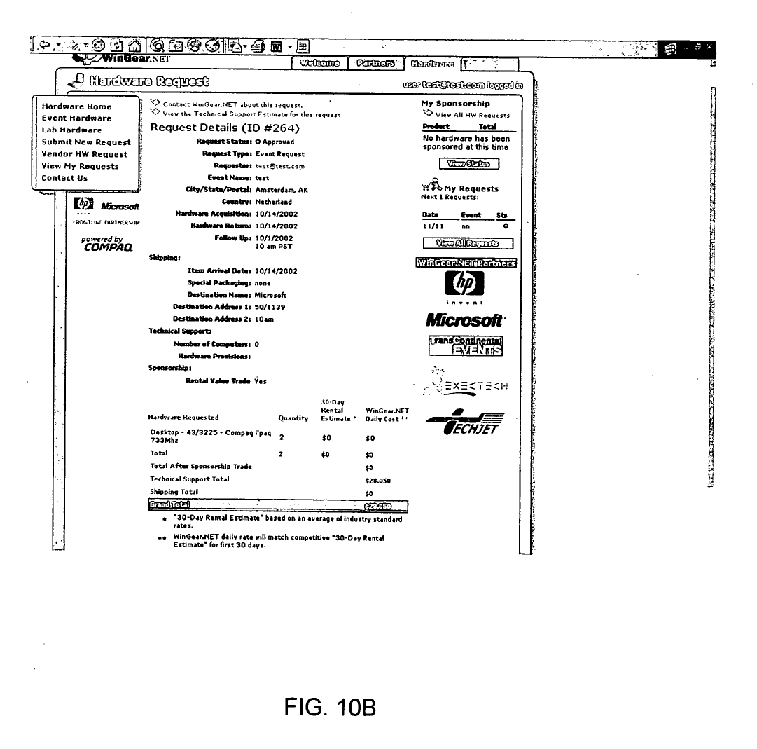

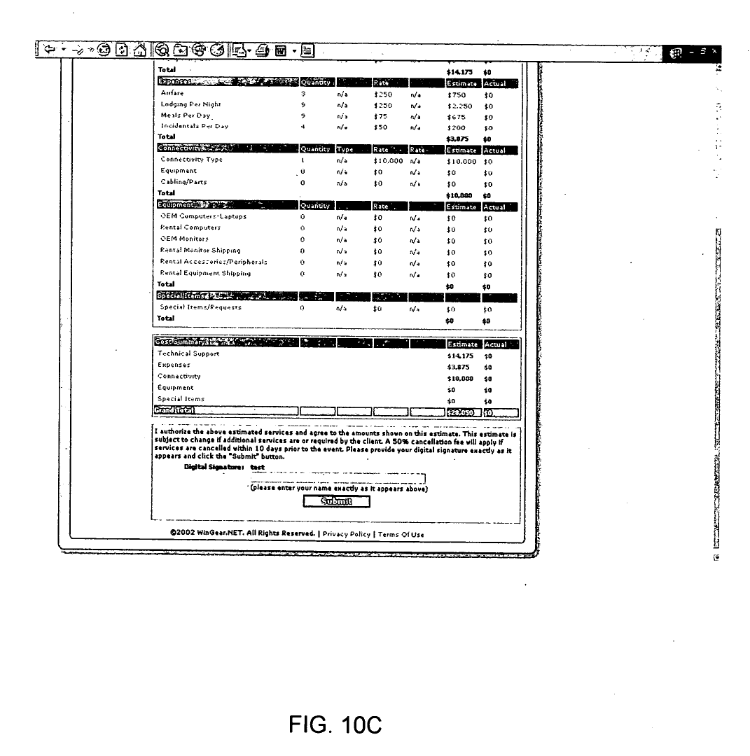

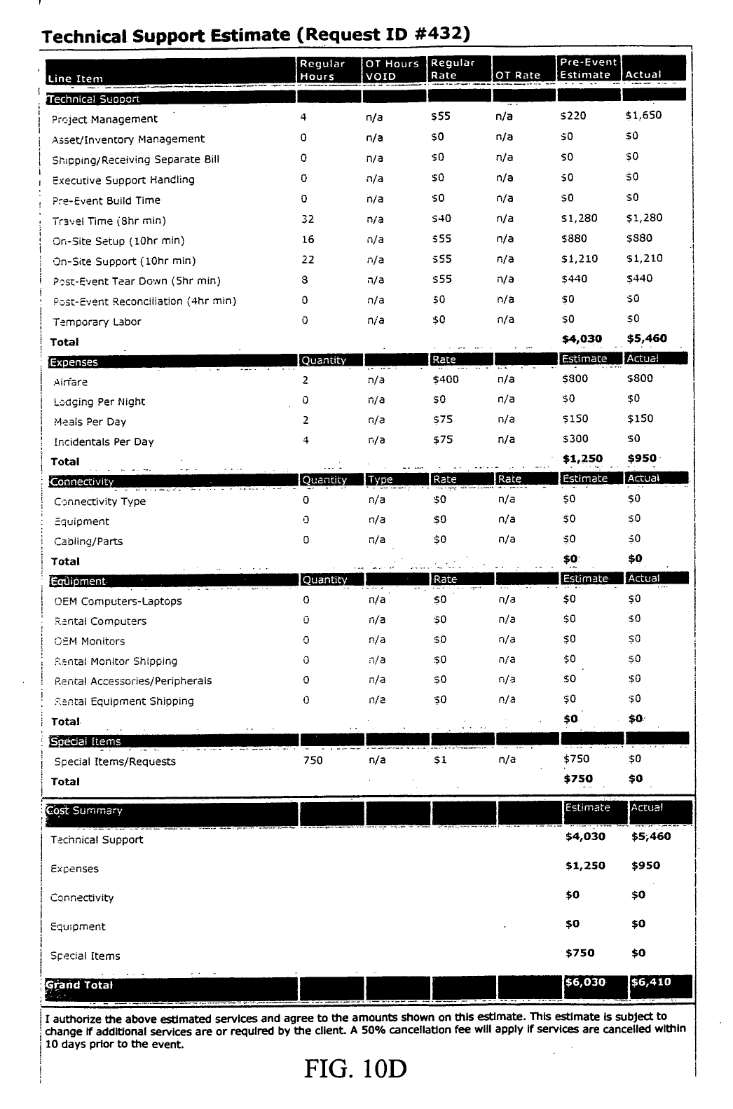

If, in step 155, the event owner accepts the sponsorship offer, processing instead proceeds to step 195, in which the effect of the sponsorship offer is presented to the user (see e.g. summary 720 in FIG. 7C). Processing thereafter progresses to steps 190 and 185, in which the agent server 235 queries the event owner for and carries out the event owner's legal approval through e.g. an electronic contracting procedure (such as that shown in FIGS. 8A-8B, FIG. 9) Such contracting may include selection and utilization of one or more standard forms appropriate to the accepted offer, and/or may include a custom-assembled contract having one or more clauses selected based on at least one the event, the event owner, the provider, and the circumstances of the sponsorship offer. Once contracting is in place, sponsorship offer negotiation and disposition for the embodiment shown in FIG. 1C terminates.

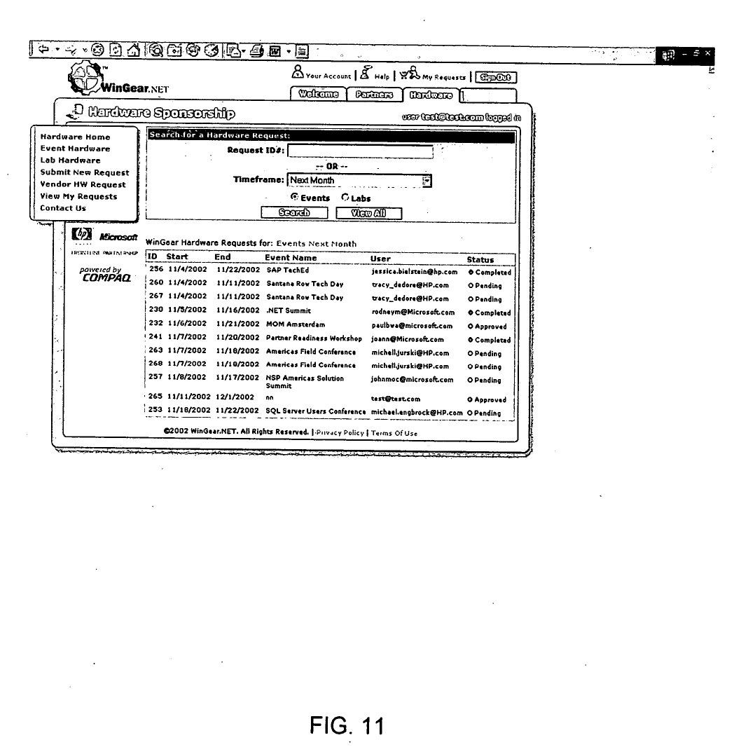

Note here that request submission (FIG. 1A), offer management (FIG. 1B), and sponsorship offer negotiation and disposition (FIG. 1C) aspects of the present embodiment may be conveniently be undertaken in parallel by the system shown in FIG. 2. Therefore, the agent server 235 should have sufficient computing resources to provide directly or manage the execution of such processing in a substantially parallel manner (or least a sequential manner if only a single event owner/request is contemplated), along with management of the request database 260. In addition, the agent server 235 may allow access to requests specified for a particular assets/services provider through a web interface, such as that shown in FIG. 11.

It will be obvious to those having skill in the art that many changes may be made to the details of the above-described embodiments without departing from the underlying principles of the invention. The scope of the present invention should, therefore, be determined only by the following claims.

### Appendix

“New Accounts” Page

1. Name (first/last)

2. Email (Company Email)

3. Title

4. Office Phone

5. Cell Phone

6. Street address/City/State and.or Country/Zip Code

7. Billing Information (credit cards/PO/Cost Center/IO)

8. Comments section for new user

User Requirements for: “Sponsor”

1. Receive updates on newly posted Marketing Oppty's from selected categories

2. “CONTACT US” link: sponsor to submit an email to eSponsor.NET

3. Approved sponsor accounts can view pricing for all “Marketing Oppty's”

4. Sponsor can sign up for an account with the auto generated email invitation process like CompuGear.NET. in the dialogue box

a. “Please use your corporate email address when submitting your user information”

b. details for sponsor to include: name/address (including int'l country code)/office phone (int'l friendly)/cell phone (int'l friendly)

Requirements for: “ADMIN”

1. Create new “Marketing Oppty's” from any Category or Sub-Category

a. “Marketing Oppty” to have unique ID

b. Modify “Marketing Oppty”

2. Create new “sponsor account” Create new “MOO” account

3. Create new “Category” for home page (picture upload)

4. Create new “Sub-category” (picture upload)

5. “Search” feature

6. “View all Users”

7. “View All Marketing Opportunities”

“TV & Motion Pictures” (the Category) Page:

1. “TV/Cable” with a picture/icon (this is considered a sub-category)

2. “Motion Pictures” with a picture/icon (this is considered a sub-category)

“TV & Cable” (the Sub-Category) Page with Picture/Icon

Page to list the opportunities, and when clicked, they are sent to the “Marketing Opportunity” form

1. HBO—Sex and the City (this is considered the “Marketing Oppty”)

2. ABC—Survivor (this is considered the “Marketing Oppty”)

3. MTV—Real World Amsterdam (this is considered the “Marketing Oppty”)

“Motion Pictures” (the Sub-Category) Page with a Picture/Icon

Page to list the oppty's, and when clicked, the item light up and sends them to detailed “Marketing Opportunity” form

1. “Dreamworks—Mission Impossible 3” (this is considered the “Marketing Oppty”)

2. “Matt Damon Party for a Movie Release” (this is considered the “Marketing Oppty”)

“Sports” (the Category) Page:

Page to list the oppty's and when clicked, the items light up and sends them to the detailed “Marketing Opportunity” form

1. NBA (this is considered a sub-category)

2. NFL (this is considered a sub-category)

3. NHL (this is considered a sub-category)

“NBA” (the Sub-Category) Page with a Picture/Icon

1. Michael Jordan Dinner (this is considered the “Marketing Oppty”)

2. Super Sonics Cheerleaders Uniform (this is considered the “Marketing Oppty”)

“NFL” (the Sub-Category) Page with a Picture/Icon

1. Seahawks Stadium Seating (this is considered the “Marketing Oppty”)

“Technical Industry” (the Category) Page:

No Sub Category for this Section

Page to list the oppty's, and when clicked, the item light up and sends them to detailed “Marketing Opportunity” form

1. “COMDEX” (this is considered the “Marketing Oppty”)

2. “Computer Electronic Show” (this is considered the “Marketing Oppty”)

“Medical Industry” (the Category) Page:

No Sub Category for this Section

Page to list the oppty's, and when clicked, the item light up and sends them to detailed “Marketing Opportunity” form

1. “Leukemia Conference” (this is considered the “Marketing Oppty”)

2. “AIDS Fundraiser” (this is considered the “Marketing Oppty”)

General Functionality

1. Flexible content sizing

2. PDA Friendly

3. Each “Marketing Oppty” should hold an unlimited amt of document uploads

4. A global address book for all users (Sponsor and MOO)

a. Address book to have all user information including billing & payment information

5. Constants icons on any page:

a. Your Account

b. HELP (web/tech support for site)

c. Contact Us (marketing contact for site)

d. “My Sponsorships” list

e. “My Marketing Oppty's” list

Requirements for: HOME PAGE

1. LEFT NAV BAR:

Contact Us—Support@eSponsor.NET

FAQ's

Sign up for a new account—

2. eSponsor.NET to provide user's a “My Marketing Oppty's” section user's profile when logged in

Section to have: “Date/Mktg Oppty/Status”

3. eSponsor.NET to provide user's a “My Sponsorships” section in their user profile when logged in

Section to have: “Date/Mktg Oppty/Status”

4. eSponsor.NET to provide user's a “View All Oppty's Available” link as shortcut under specified category

Need the “Categories” with a check box for users to control for this feature to be enabled

Section to have: “Date/Category/Mktg Oppty”

5. MAIN REAL ESTATE

“TV & Movies” with picture/icon (this is considered a “category”)

“Sports” with picture/icon (this is considered a “category”)

“Technical Industry” with picture/icon (this is considered a “category”)

Requirements for “Marketing Oppty” (Item for Sale)

1. Statuses:

a. Considering

b. Pending

c. Approved

d. Completed

e. Denied

f. Sponsorship Secured

2. Document Upload Section:

a. Terms and Conditions

b. MOO Agreement

c. Sponsor logo/branding

d. Banner mock-up

e. Collateral mock-up

3. Links:

a. “Contact eSponsor.NET about this marketing opportunity”

b. “View a printable version of this marketing opportunity”

c. “View a printable version of this marketing agreement”

d. “View the eSponsor.NET Terms and Conditions”

e. “Print the eSponsor.NET Terms and Conditions”

f. “View the support estimate for this marketing opportunity” FOR ADMIN ONLY

4. Date

5. Title

6. Location

7. Level

a. Platinum

b. Gold

c. Silver

d. Bronze

e. Pearl

f. Exclusive

g. “other”

8. Investment Dollars (price tag)

9. URL

10. Description (unlimited chars)

11. Event/project logo (upload)

12. Sponsorship Contact

a. Primary: Name/Phone numbers—2 listed (office & cell)/Email

b. Secondary: Name/Phone numbers—2 listed (office & cell)/Email

13. Target Audience

14. Deadline for Response

15. Audience Size/Reach

16. Primary Objectives

17. Can this oppty be negotiable with sponsor? “yes/no check box”

18. Demand Generation Plans (list):

a. Add new detail to include

i. Plan description (ex. Press Release)

ii. Contact from the MOO (ex. Press Release contact)

iii. Deadlines associated

iv. Document upload (ex. Press Release from Sponsor or MOO)

b. Assign contact for demand generation owner to include:

i. Name/Phone numbers—2 listed (office & cell)/Email

c. Delete Demand Generation Detail

d. Comments/Notes section (unlimited chars.)

19. Deliverables/Exposure: (list)

a. Add new detail to include:

i. Deliverable description

ii. Contact from the MOO

iii. Deadlines associated with deliverable

iv. Document upload

v. Comments/Notes section (unlimited charss)

b. Delete deliverable

“Marketing Opportunity Request Receipt from eSponsor.NET” page:

“Thank you Amy@hp.com for your inquiry. One of our marketing specialists will contact you at the time your specified on your inquiry form. If the time you have nominated is booked, we will promptly notify you to reschedule the interview. Please make note of the interview process taking up to 45 minutes”.

“Your inquiry is for the “Marketing Oppty” only” (have the title replace the “marketing oppty”)

“Additional value-add services (through eSponsor.NET alliances) are available to combine with your marketing endeavors:

Hardware provisions

On site equipment set up & tear down, inventory & removal

Internet, Network Connectivity and Wireless Mobility

Extended on site hardware support

Extended on site software imaging and technical support

On site event hardware, software testing

On site event shipping & receiving

Software pre-load & imaging.

Logistics

Collateral

“If you are interested in a FREE QUOTE for any of the above services, please email us at FreeQuotes@eSponsor.NET”

“The following identification number has been assigned to your inquiry”

<request ID here>

“Please retain this ID for your records”

“Warmly,”

“Your team at eSponsor.NET”

User Requirements for: “Mktg Oppty Owner” (MOO)

1. MOO to provide details for the item description (sponsor admin to assist completing form

2. MOO to provide marketing agreement/contract between them and sponsor

3. eSponsor.NET provides MOO a “My Marketing Oppty's” section in their user profile

4. eSponsor.NET provide MOO a “My Sponsorships” section in their user profile

5. eSponsor.NET provide MOO a “View all Oppty's Available” link as shortcut under specified category.

Need categories as check boxes for this feature

6. MOO provide the official digital signature for their marketing oppty

7. MOO to sign the official digital signature for Marketing Agreement between them and sponsor

8. MOO provide the official digital signature for Terms and Conditions between them and eSponsor.NET

What is claimed is:

1. A method for carrying out a sponsorship exchange, comprising:
recording a request of at least one asset or service submitted by an event owner in connection with an event;
determining whether the event owner is interested in trading at least one sponsorship opportunity to at least partially defray a cost associated with the request; and
if the event owner is determined to be interest in trading the at least one sponsorship opportunity, performing the following:
presenting to the event owner a sponsorship offer; and
facilitating an agreement as to the sponsorship offer.

2. A method for carrying out a sponsorship auction, comprising:
defining a plurality of sponsorship opportunities associated with at least one of an event, an entity, and an event owner;
taking at least one bid associated with at least one of the sponsorship opportunities;
recognizing the at least one bid as a winning bid based on a comparison of the bid to predetermined criteria associated with the corresponding sponsorship opportunity and to one or more competing bids; and
transmitting the winning bid to at least one of the entity and the event owner.
